(19) United States
(12) Patent Application Publication
(10) Pub. No.: US 2021/0148833 A1
(43) Pub. Date: May 20, 2021

(54) Soiling Measurement Device for Photovoltaic Arrays

(71) Applicants: Michael Gostein, Austin, TX (US); Stan Faullin, Round Rock, TX (US); William Stueve, Austin, TX (US)

(72) Inventors: Michael Gostein, Austin, TX (US); Stan Faullin, Round Rock, TX (US); William Stueve, Austin, TX (US)

(21) Appl. No.: 16/952,258

(22) Filed: Nov. 19, 2020

Related U.S. Application Data
(60) Provisional application No. 62/938,071, filed on Nov. 20, 2019.
(60) Provisional application No. 63/010,109, filed on Apr. 15, 2020.

(51) Int. Cl. G01N 21/94; G01J 1/04; G01J 1/18; G01N 21/88; H02S 50/15

(52) U.S. Cl. CPC G01N 21/94; G01J 1/0411; G01J 2001/1636; G01N 21/8806; H02S 50/15; G01J 1/18

(57) ABSTRACT

In one respect, disclosed is a soiling measurement device for measuring the loss of light transmission to photovoltaic (PV) devices in a photovoltaic array arising from the accumulation of soiling particles, comprising a light source, a reference photodetector, a soiling collection window, a photodetector positioned underneath the soiling collection window, and a measurement and control system.

### CROSS-REFERENCE TO PRIOR APPLICATIONS

This application claims priority to U.S. Provisional Patent Application No. 62/938,071 filed Nov. 20, 2019 and U.S. Provisional Patent Application No. 63/010,109 filed Apr. 15, 2020.

### STATEMENT OF GOVERNMENT INTEREST

This invention was made with U.S. Government support under DE-SC0020012 and DE-SC0020813 awarded by the Department of Energy. The U.S. Government has certain rights in this invention.

### FIELD OF THE INVENTION

The disclosed subject matter is directed to the measurement of soiling losses on photovoltaic (PV) arrays for solar energy production.

### SUMMARY

In one respect, disclosed is a soiling measurement device for measuring the loss of light transmission to photovoltaic (PV) devices in a photovoltaic array arising from the accumulation of soiling particles, comprising a light source, a reference photodetector, a soiling collection window, a photodetector positioned underneath the soiling collection window, and a measurement and control system.

### BRIEF DESCRIPTION OF THE DRAWINGS

FIG. 1 depicts an embodiment of a soiling measurement device according to the disclosed subject matter.

FIG. 2 depicts a cross-sectional view showing accumulation of soiling particles (304) on a soiling collection window (302) illuminated by a light beam (208).

FIG. 3 depicts an exploded view of a light source assembly (200) depicted in FIG. 1.

FIG. 4 depicts a close-up view of selected components shown in FIG. 3.

FIG. 5 depicts a cross-sectional view of a light source assembly (200) depicted in FIG. 3, with cutaways for clarity of reference labels.

FIG. 6 depicts an embodiment of a light source (202) with a reflector (238).

FIG. 7 depicts an embodiment of a light source (202) with a lens (244).

FIG. 8 depicts a block diagram of an embodiment according to the disclosed subject matter.

FIG. 9 depicts a flowchart of an embodiment according to the disclosed subject matter.

### DETAILED DESCRIPTION OF THE INVENTION

Solar panels, also known as photovoltaic (PV) modules, are used to convert sunlight to electric power in installations known as PV arrays. An important loss factor for a PV array is the accumulated deposition of airborne particulate matter on the light-receiving surfaces of the PV modules. This accumulation, known as soiling, reduces the power output of a PV array by blocking the transmission of sunlight to the PV cells of the PV array. Soiling particles (304) consist of any airborne particulate matter, such as dust, dirt, soot, pollen, etc., which deposits on a PV array, and have typical diameters ranging from ˜0.2 microns to ˜200 microns. In dusty outdoor regions without frequent rainfall, the power loss due to soiling, known as soiling loss, can be significant.

In commercial electric power generation applications, which range from small ground-mounted and roof-mounted PV arrays to large utility-scale projects, owners and operators of PV arrays often wish to measure losses due to soiling. Motivations include, but are not limited to, pre-construction assessment of soiling loss as an aid to site selection and performance estimation, validation and monitoring of the performance of an operating PV array, and determination of when to wash a PV array in order to yield greatest return on investment for the expense of washing.

The soiling level, also called soiling loss or transmission loss, is the portion of loss due to soiling particles (304) in the usable light received by the PV cells of the PV array, relative to a clean state. A clean state is a reference state in which the transmission loss due to soiling particles (304) is negligible, for example less than 1%. In some embodiments, the soiling level may be defined as the fractional loss in the usable light received, relative to a clean state. Usable light means light that is absorbed by the PV array and is converted, or could be converted, to electrical output. Equivalently, the soiling level can be defined as one minus the fractional transmission of usable light through the layer of soiling particles (304), relative to a clean state. In the absence of soiling particles (304) the transmission so defined, in some embodiments, is 100% and soiling level is 0%, i.e. transmission is defined relative to the clean state of the device ignoring any other losses not due to soiling. The soiling ratio is defined as the ratio of the PV array electrical output to its expected output in a clean state, or, equivalently, as the fractional transmission of usable light. The measurement of any of soiling level, soiling loss, transmission loss, transmission, or soiling ratio could also be defined relative to another reference state instead of or in addition to a clean state. The measurement of any of soiling level, soiling loss, transmission loss, transmission, or soiling ratio is equivalent, as each is an expression of the loss due to soiling. It should be noted that soiling level, soiling loss, transmission loss, transmission, or soiling ratio may also be defined using alternative mathematical functions and/or scales, where such scales include for example fractional values, percentages, logarithmic scales, units of power, and units of energy, and that each of these alternative terms, mathematical functions, and/or scales is intended to be within the scope of this disclosure.

In some embodiments, disclosed is a soiling measurement device that is deployed outdoors and is configured to measure a soiling level characteristic of a nearby PV array or of a prospective PV array to be constructed at a nearby location.

In some embodiments, disclosed is a soiling measurement device that does not require routine cleaning to perform its measurement.

In some embodiments, disclosed is a soiling measurement device comprising a light source (202), a reference photodetector (204), a soiling collection window (302), a photodetector (306) positioned underneath soiling collection window (302), and a measurement and control system. Soiling particles (304) accumulate on soiling collection window (302) causing a reduction in light transmission to photodetector (306). Reference photodetector (204) is unaffected by soiling particles (304) and serves to measure the intensity of light source (202). Comparison of signals from photodetector (306) and reference photodetector (204) using calibration values relative to a clean state of said soiling collection window (302) yields a measurement of soiling loss.

In some embodiments, a soiling measurement device according to the disclosed subject matter is configured to address one or more of the following objectives: minimizing measurement errors due to fluctuations or drift of intensity of light source (202), including fluctuations or drift to temperature variations; minimizing measurement errors due to fluctuation in relative mechanical alignment of light source (202) and photodetector (306); minimizing measurement errors due to accumulation of soiling, insects, and/or other debris blocking the output of light source (202); maximizing the time that the device operates effectively without being cleaned; minimizing the degree to which any portion of the device obstructs the natural flow of soiling particles (304) to soiling collection window (302); minimizing total energy consumption of the device; allowing operation of the device in daylight or office ambient illumination conditions for the convenience of personnel working with the device.

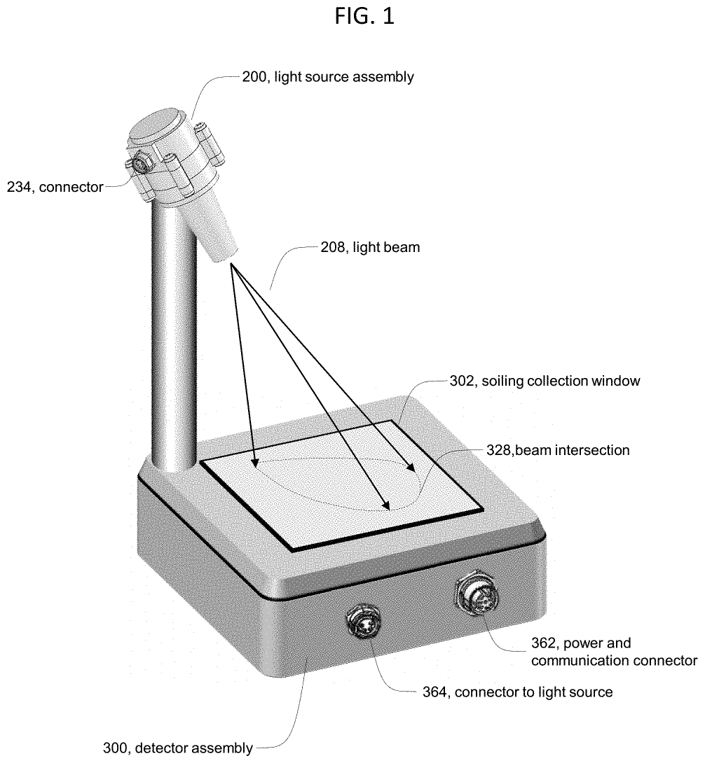

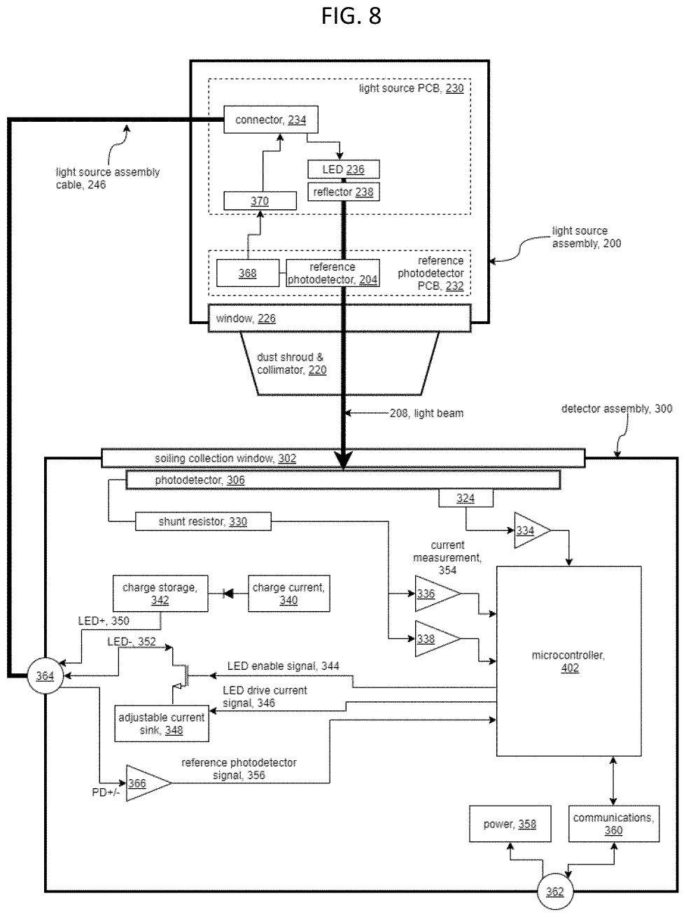

FIG. 1 depicts an embodiment of a soiling measurement device according to the disclosed subject matter. A light source assembly (200) directs a light beam (208) to illuminate a soiling collection window (302) on a detector assembly (300). The perimeter of the beam spot or the extent of illumination of light beam (208) within the plane of soiling collection window (302) is denoted as beam intersection (328). In some embodiments light source assembly (200) is electrically connected to detector assembly (300), in some embodiments utilizing light source assembly cable (246) (depicted in FIG. 8) connected between connector (234) and connector to light source (364). In some embodiments power and communication connector (362) provides wiring for power and communication signals. The device is configured for outdoor use and therefore in some embodiments incorporates seals to prevent water entry to sensitive electronic and optical assemblies.

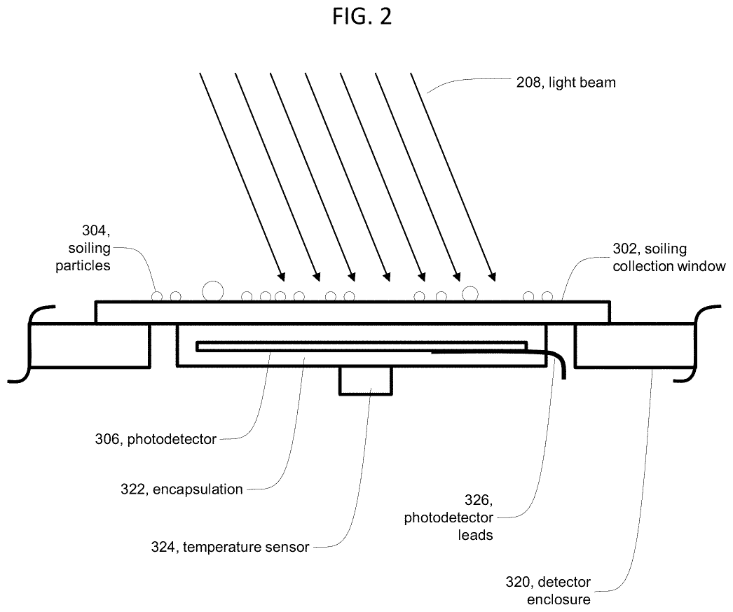

In some embodiments light source assembly (200) is directed substantially downward to minimize accumulation of dust and other debris which would attenuate its output. In some embodiments, light source assembly (200) is positioned substantially outside the region directly above detector assembly (300), as depicted in FIG. 2, minimizing the degree to which light source assembly (200) obstructs the natural flow of soiling particles (304) to soiling collection window (302). In some embodiments light beam (208) impinges on soiling collection window (302) at a nominal angle between 10 and 40 degrees. In some embodiments, impingement angle is chosen to approximately represent an effective angle of incidence of sunlight on a PV array, to maximize correspondence of readings from the device with losses on a PV array due to soiling particles (304).

In some embodiments beam intersection (328) of light beam (208) on the plane of soiling collection window (302) is configured to fall substantially completely within the boundaries of soiling collection window (302) and photodetector (306) (as depicted in FIG. 2), minimizing the degree of variation in signal from photodetector (306) due to variations in mechanical alignment of light source assembly (200), including fluctuations due to wind, vibrations, and other post-installation factors. For example, beam intersection (328) may be configured such that >95% or >99% of energy of light beam (208) is received by an area of soiling collection window (302) directly above photodetector (306).

FIG. 2 depicts a cross-sectional view of soiling collection window (302) mounted to detector enclosure (320) of detector assembly (300). Light beam (208) illuminates soiling collection window (302) and is transmitted through soiling collection window (302) to photodetector (306). Soiling particles (304) accumulate on soiling collection window (302). Accumulation of soiling particles (304) reduces transmission of light beam (208) to photodetector (306). In some embodiments, photodetector (306) comprises a PV cell with encapsulation (322). Photodetector leads (326) are used for electrical measurement of the response of photodetector (306) to light beam (208). In some embodiments a temperature sensor (324) measures a temperature of photodetector (306), as depicted in FIG. 2, or another related temperature.

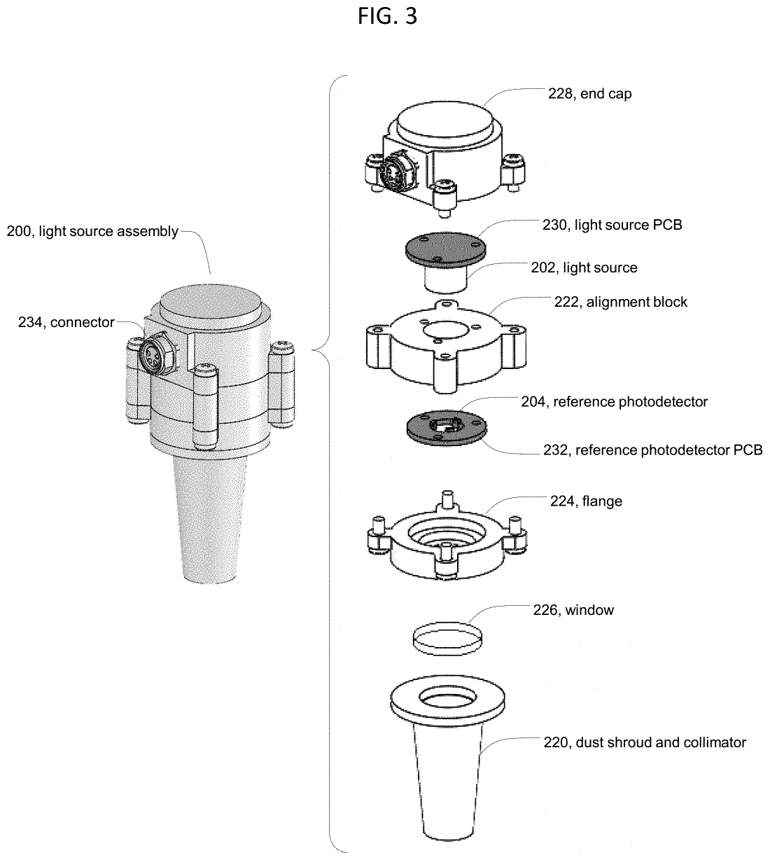

FIG. 3 depicts an exploded view of an embodiment of light source assembly (200) depicted in FIG. 1. Light source (202) emits light which illuminates reference photodetector (204) and ultimately passes through window (226). In some embodiments, light exiting window (226) additionally passes through dust shroud and collimator (220). In some embodiments these components are mechanically assembled using alignment block (222), flange (224), and end cap (228), and in some embodiments light source (202) is implemented on a printed circuit board light source PCB (230) while reference photodetector (204) is implemented on reference photodetector PCB (232).

In some embodiments a dust shroud and collimator (220) serves to protect window (226) from dust and/or other debris which would block or attenuate output of light source assembly (200) and in some embodiments additionally serves to collimate light beam (208) and restrict the extent of beam intersection (328) to fall within an optimal region of soiling collection window (302) directly above photodetector (306). In some embodiments dust shroud and collimator (220) preferentially has an aspect ratio of length:diameter>2:1, to minimize the flow of dust and/or other debris into light source assembly (200), and an opening diameter of greater than approximately 5-10 mm to minimize the potential for clogging of dust shroud and collimator (220) by dust, insects, and/or other debris.

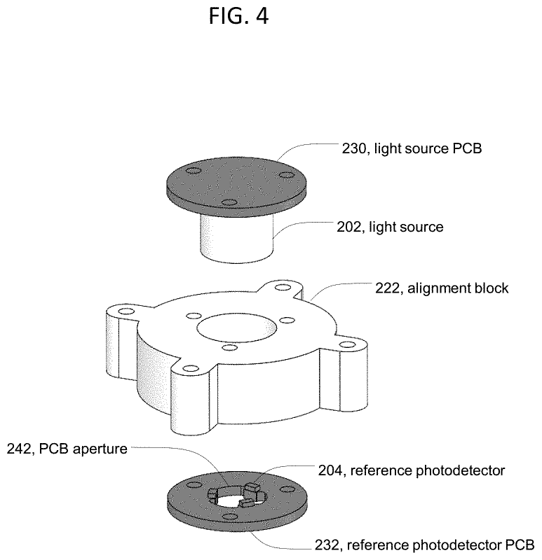

FIG. 4 depicts a close-up view of light source (202), reference photodetector (204), alignment block (222), light source PCB (230), and reference photodetector PCB (232) depicted in FIG. 3. In some embodiments reference photodetector (204) comprises a photodiode. In some embodiments reference photodetector (204) comprises multiple instances, as depicted in FIG. 4, configured to capture light from light source (202) at various positions. In some embodiments, signals from each reference photodetector (204) are combined to yield an average or sum, whereby they together effectively act as one reference photodetector (204). In some embodiments PCB aperture (242) in reference photodetector PCB (232) provides a path for light from light source (202). In some embodiments each reference photodetector (204) is placed on a protrusion of reference photodetector PCB (232) into PCB aperture (242) maximizing the open area of PCB aperture (242).

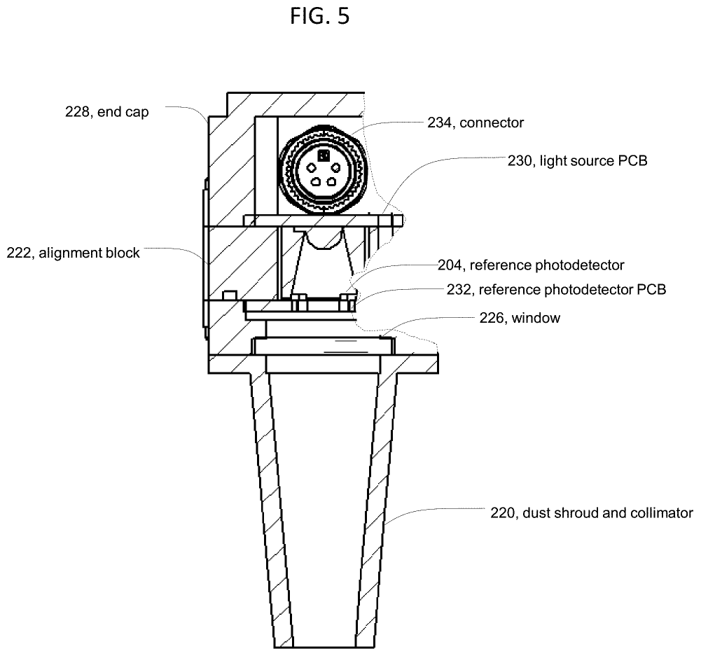

FIG. 5 depicts a cross-sectional view of an embodiment of light source assembly (200) depicted in FIG. 3. Light from light source (202), implemented on light source PCB (230), is directed to one or more of reference photodetector (204) implemented on reference photodetector PCB (232) and passes through window (226) and ultimately through dust shroud and collimator (220). In some embodiments these components are assembled using alignment block (222) and end cap (228). In some embodiments the space between LED (236) and window (226) is filled with a transparent potting compound to prevent moisture entry or condensation on optical surfaces, wherein the optical properties of such potting compound and of reflector (238) are chosen to enable reflection of LED rays (240) from reflector (238); for example, potting compound may have an index of refraction similar to glass and reflector (238) may be metalized.

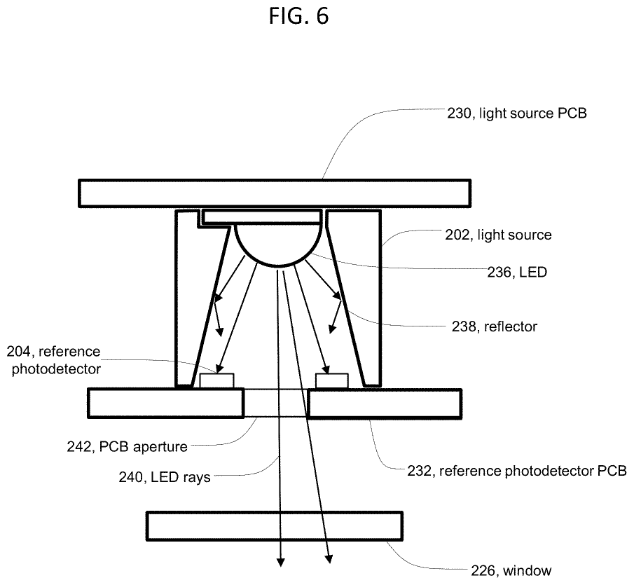

FIG. 6 depicts a cross-sectional view of an embodiment of light source (202) and related components. In some embodiments light source (202) comprises one or more of light-emitting diode LED (236) on light source PCB (230). In some embodiments LED rays (240) are collimated by reflector (238). A portion of LED rays (240) illuminate reference photodetector (204) which in some embodiments is implemented on reference photodetector PCB (232) having PCB aperture (242) allowing LED rays (240) to exit to window (226).

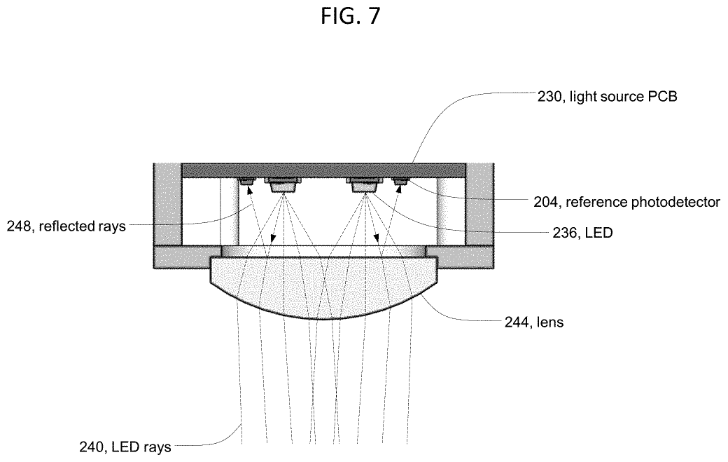

FIG. 7 depicts a cross-sectional view of another embodiment of light source (202) and related components. In some embodiments light source (202) comprises light source PCB (230) which further comprises one or more of LED (236) as well as reference photodetector (204). In some embodiments lens (244) serves to collimate LED rays (240) and in some embodiments may serve the additional function of replacing window (226). In some embodiments a portion of LED rays (240) reflect from a surface of lens (244) or alternatively from a surface of window (226) to form reflected rays (248) which illuminate one or more of reference photodetector (204), providing feedback on intensity of light emission from LED (236).

FIG. 8 depicts an exemplary block diagram of a soiling measurement device according to the disclosed subject matter and similar to the embodiment depicted in FIG. 1. Detector assembly (300) comprises photodetector (306) beneath soiling collection window (302) in a sealed enclosure; microcontroller (402) which performs control, measurement, and communication functions; power (358) and communications (360) circuitry which in an exemplary embodiment are connected to power and communications connector (362); and additional circuitry for powering light source assembly (200) and measuring various signals.

In some embodiments the soiling measurement device of FIG. 8 is configured to generate continuous light from light source assembly (200) while in other embodiments the device is configured to generate pulses of light from light source assembly (200). In some embodiments configured to generate pulses of light, a charge current (340) circuit provides charge to a charge storage circuit (342) such as a capacitor bank. An LED enable signal (344) from microcontroller (402) enables current to flow from charge storage (342) via lines LED+ (350) and LED− (352), which ultimately power LED (236), to adjustable current sink (348) programmed by an LED drive current signal (346) from microcontroller (402). In some embodiments adjustable current sink (348), which permits precise and programmable control of LED (236) intensity, is replaced with a fixed current sink or emitted altogether.

Drive current between LED+(350) and LED− (352) is transferred via a connector to light source (364) and light source assembly cable (246) to light source assembly (200), entering at connector (234) and reaching one or more of LED (236) on light source PCB (230) causing light emission. In some embodiments light emitted by LED (236) is collimated by reflector (238). A portion of light from LED (236) is received by one or more of reference photodetector (204) on reference photodetector PCB (232), providing feedback on intensity of light from LED (236). A portion of light from LED (236) transmits through window (226) and through dust shroud and collimator (220) as light beam (208) which transmits through soiling collection window (302) and is received at photodetector (306). Soiling particles (304) (depicted in FIG. 2) attenuate transmission of light beam (208) through soiling collection window (302). Photodetector (306) produces a signal, such as by conduction of current through shunt resistor (330), according to intensity of light received from light beam (208), and said signal is measured by current measurement (354) circuits connected to microcontroller (402).

In some embodiments current measurement (354) circuits comprise one or more sub-circuits with various gain and/or frequency filter configurations optimized for different light levels and signal types. In an exemplary embodiment current measurement (354) circuits include a low-gain circuit (336) configured for optimal sensitivity to levels of slowly varying background ambient light such as daylight or office lighting and/or a high-gain high-pass circuit (338) configured for optimal sensitivity to comparatively weaker but pulsed light from light beam (208).

Reference photodetector (204) generates a signal, in proportion to intensity of light from LED (236), which is transmitted—for example via reference photodetector PCB subconnector (368), light source PCB subconnector (370), connector (234), light source assembly cable (246), and connector to light source (364)—ultimately to reference photodetector signal amplifier (366) generating reference photodetector signal (356) which is measured by microcontroller (402).

In some embodiments temperature sensor (324) in conjunction with temperature sensor amplifier (334) measures a temperature of photodetector (306) or another related temperature and microcontroller (402) uses this temperature for temperature compensation of results.

In some embodiments, operating light source assembly (200) in a pulsed mode achieves one or more of the following objectives: minimizing heating of light source (202) which could lead to drift or fluctuation in light output; facilitating performing measurements at high background ambient light levels, for example in daylight or office lighting, by allowing subtraction of signal from ambient light as described below; minimizing total energy consumption; and minimizing nighttime attraction of insects. In some embodiments pulse durations may range from microseconds to minutes or may be chosen according to rates of fluctuation of ambient light. In some embodiments pulse period, frequency, or duty cycle may be chosen to minimize energy consumption and/or nighttime attraction of insects.

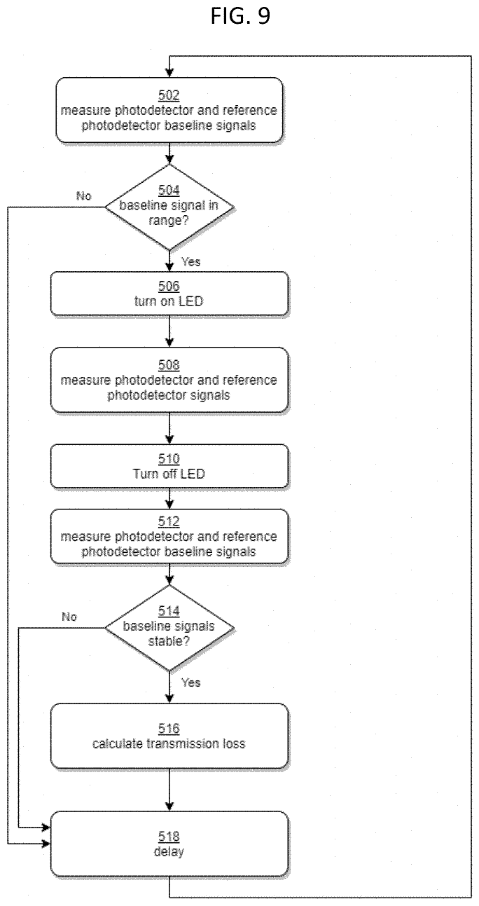

FIG. 9 depicts an exemplary flowchart of a sub-portion of operations of a soiling measurement device corresponding to an embodiment similar to FIG. 8. In a first step (502) the device measures photodetector (306) and reference photodetector (204) baseline signals while LED (236) is off, prior to a pulse, where baseline signals are generated by ambient light. Subsequently in step (504) the device determines whether measured baseline signals are within an acceptable range for measurement; for example, in some embodiments the device is configured to operate only at night, when baseline signals are low, while in other embodiments the device is configured to operate only during the day, to avoid attracting insects to light beam (208) by nighttime illumination and/or to provide measurement results when personnel are working. If baseline signals are within an acceptable range in step (504), subsequently in step (506) the device initiates a pulse, turning on LED (236), and in step (508) measures signals from photodetector (306) and reference photodetector (204) during the pulse, thereafter in step (510) turning off LED (236) ending the pulse. In some embodiments LED (236) is maintained turned on for only a short pulse duration, for example between 1 and 100 milliseconds, providing sufficient time for measuring adequate signal while minimizing energy consumption and minimizing illumination which could attract insects. Immediately after turning off LED (236), in some embodiments in step (512) the device measures again the baseline signals from photodetector (306) and reference photodetector (204) and in step (514) compares these signals to those measured in step (502) to determine if variation in baseline signal levels, for example due to fluctuations in background levels of sunlight or office lighting, is within an acceptable range for measurement without adversely affecting accuracy. If variation in baseline signals is acceptable, in step (516) the device calculates transmission loss due to soiling particles (304) using stored calibration constants as outlined below in further detail. Subsequently in step (518) a delay is initiated before beginning the cycle again at step (502); the delay together with this pulse width for LED (236) serves to limit the duty cycle of LED (236), minimizing energy consumption and minimizing the nighttime attraction of insects.

Operation of a device according to the disclosed subject matter is further illustrated with an exemplary equation for measured transmission loss (TL) wherein in some embodiments TL=1−C*(P−PB)/(R−RB). Here PB and RB are respectively photodetector (306) and reference photodetector (204) baseline signals measured with LED (236) off as determined by measurements taken before and/or after turning on LED (236); P and R are respectively photodetector (306) and reference photodetector (204) signals measured with LED (236) on; and C is a calibration factor with a value determined such that measured transmission loss TL equals 0 when soiling collection window (302) is in a clean state or related reference state and such that TL equals 1 when soiling collection window (302) is completely dirty blocking substantially all light transmission.

Measurement of PB and RB baseline signals permits the device to operate with background light levels which may be significant, for example due to ambient sunlight or office lighting, compared to the intensity produced by light beam (208) alone. In some embodiments significant ambient light includes light causing baseline signals PB and/or RB to be for example at least 1% of corresponding full signals P and/or R, respectively and up to for example>90% of corresponding full signals P and/or R, respectively.

Measurement of reference photodetector (204) signals R and RB serves to minimize error in TL due to variations in intensity of light beam (208) caused by fluctuations or drift of output of LED (236) or any other aspect of light source (202).

In some embodiments calibration factor C is a function of light level measured by any of the signals P, PB, R, and/or RB, in order to account for light-dependent response of the system, including for example non-linearities in response of photodetector (306) and/or reference photodetector (204) as well as other potential non-linearities. In some embodiments linear or non-linear contributions to calibration factor C are determined by calibrating at varying levels of baseline light level, determining values of calibration factor C which cause measured transmission loss TL to equal 0 or 1 respectively under the required conditions at each light level, and determining an equation for C as a function of light level.

In some embodiments calibration factor C is a function of temperature measured by temperature sensor (324) and/or other temperature sensors such as temperature sensors integrated within microcontroller (402). Inclusion of temperature dependence in calibration factor C allows compensation for temperature-dependent variations in the relative response of photodetector (306) and reference photodetector (204).

In some embodiments the spectral output of light source (202) is chosen to minimize the temperature dependence and/or relative temperature dependence of photodetector (306) and reference photodetector (204). For example, when photodetector (306) and/or reference photodetector (204) comprise silicon photodiodes or solar cells, the spectral output of light source (202) may be chosen to exclude light with wavelength longer than approximately 1000 nm, since temperature dependence of silicon photovoltaic devices arises from temperature dependent variations of the silicon absorption band edge.

In some embodiments the spectral output of light source (202), for example as generated in some embodiments by one or more of LED (236), is chosen to match within practical considerations the spectral output of sunlight, in order to make a soiling measurement device according to the disclosed subject matter best estimate effective transmission loss of sunlight to a PV array as affected by spectrally dependent transmission of soiling particles (204). For example, light source (202) may be implemented with a white light LED (236) in preference to a single-color LED (236).

Specific components indicated in the figures and description are exemplary and objectives of the device could be achieved by modifying, substituting, duplicating, combining, or omitting various components while remaining within the scope of this disclosure.

1. A soiling measurement device for photovoltaic arrays comprising:
a light source assembly, comprising
a light source and
a reference photodetector;
a detector assembly, comprising
a soiling collection window and
a photodetector positioned beneath said soiling collection window; and
a controller;
wherein said reference photodetector is configured to measure at least a portion of light emitted by said light source, and
wherein said photodetector is configured to measure at least a portion of light emitted by said light source and transmitted through said soiling collection window, and
wherein said controller is configured to determine a fractional transmission loss of light through said soiling collection window relative to a clean or reference state, arising at least from accumulation of soiling particles on said soiling collection window, based at least upon measurements of said reference photodetector, measurements of said photodetector, and a calibration value.

2. The device of claim 1, wherein said light source is collimated into a beam, and wherein the intersection of said beam with a plane defining said soiling collection window lies entirely within a region of said soiling collection window directly above said photodetector.

3. The device of claim 2, comprising a dust shroud and collimator protecting said light source, wherein said dust shroud includes an open aperture, and wherein said open aperture defines said beam.

4. The device of claim 1, wherein said light source is configured substantially outside a region directly above said detector assembly and impinges on said soiling collection window at a substantially non-normal angle of incidence.

5. The device of claim 1, wherein said light source is configured to operate in a pulsed mode.

6. The device of claim 5, wherein in the presence of ambient light, background measurements of said photodetector before and/or after a light source pulse are substantial compared to measurements of said photodetector during said light source pulse, and wherein said background measurements of said photodetector before and/or after said light source pulse are subtracted from said measurements of said photodetector during said light source pulse.

7. The device of claim 6, wherein said calibration value comprises a dependence on said measurements of said photodetector before, after, and/or during said pulse, compensating for intensity-dependence of response of said photodetector.

8. The device of claim 1, comprising at least one temperature sensor, and wherein said calibration value comprises a dependence on said at least one temperature sensor.

9. The device of claim 1, wherein said light source assembly comprises a lens or window, wherein said light passes through said lens or window, and wherein at least a portion of said light is reflected by said lens or window to said reference photodetector.

10. A method for measuring a soiling loss characteristic of a photovoltaic array, comprising:
generating a beam of light from a light source,
directing at least a portion of said beam to a reference photodetector,
directing at least a portion of said beam to a photodetector underneath a soiling collection window,
allowing said soiling collection window to accumulate soiling particles,
measuring a signal from said reference photodetector and a signal from said photodetector, and
determining a fractional transmission loss of light through said soiling collection window relative to a clean or reference state, arising at least from accumulation of said soiling particles on said soiling collection window, based at least upon measurements of said reference photodetector, measurements of said photodetector, and a calibration value.

11. The method of claim 10, comprising collimating said light source into a beam wherein the intersection of said beam with a plane defining said soiling collection window lies entirely within a region of said soiling collection window directly above said photodetector.

12. The method of claim 10, comprising compensating for ambient light by generating pulses from said light source, measuring said signals from said photodetector and/or said reference photodetector during said pulses and before and/or after said pulses, and subtracting said signals measured before and/or after said pulses from said signals measured during said pulses.

13. The method of claim 12, comprising compensating for intensity dependent response by adjusting said calibration value according to a dependence on said signals of said photodetector and/or said reference photodetector.

14. The method of claim 10, comprising compensating for temperature dependent response by measuring a temperature related to said light source, said photodetector, and/or said reference photodetector and adjusting said calibration value according to a dependence on said temperature.
